(19) United States
(12) Patent Application Publication
(10) Pub. No.: US 2025/0051146 A1
(43) Pub. Date: Feb. 13, 2025

(54) Low Headroom Hook Block for Wire Rope Hoist

(71) Applicant: Columbus McKinnon Corporation, Getzville, NY (US)

(72) Inventors: Yunji Gu, Charlotte, NC (US); Angelo Pelini, Canfield, OH (US)

(21) Appl. No.: 18/232,904

(22) Filed: Aug. 11, 2023

(51) Int. Cl. B66D 3/04; B66D 3/26

(52) U.S. Cl. CPC B66D 3/043; B66D 3/26

(57) ABSTRACT

A hook block assembly for use in low overhead applications. The hook block assembly is designed for use with a wire rope hoist system and has a first sheave assembly and a second sheave assembly adjustably mounted on a crosshead with spacers for varying the distance between the sheaves on the sheave assembly. The hook block assembly is designed for use with girders or beams having flanges with different widths. The spacers provide for adjusting the distance between the sheaves on the first and second sheave assemblies to maintain a sufficient angle of loading for permissible tension on the wire ropes.

### TECHNICAL FIELD

The present invention relates generally to the field of material handling equipment such as hoists and cranes, and more particularly to a low headroom hook block for use with a wire rope hoist.

### BACKGROUND ART

A wire rope hoist is configured with a rotating drum having spiral grooves defined therein for receiving a hoisting rope. A rope guide is configured to mount around the rotating drum. The spiral rope groove on the rotating drum is configured to receive the hoisting rope as it winds and unwinds from the rotating drum. The rope guide is configured to move laterally relative to the rotating drum to keep the hoisting rope in the spiral rope groove when winding the hoisting rope onto the rope groove or unwinding it from the rope groove. A motor drives the rotating drum which spools or unspools the wire rope thereby raising or lowering a load.

### BRIEF SUMMARY OF THE INVENTION

With parenthetical reference to the corresponding parts, portions or surfaces of the disclosed embodiment, merely for the purposes of illustration and not by way of limitation, the present invention meets the above described need by providing a hook block assembly (10).

The hook block assembly (10) includes a first sheave assembly (80) having a first side wall (83) disposed in spaced apart relation to a second side wall (86). The first sheave assembly (80) has a first end wall (98) disposed in spaced apart relation to a second end wall (107). The first and second side walls (83, 86) have one or more first sheaves (92) and second sheaves (95) disposed thereon. The first and second end walls (98, 107) have first openings (101, 110) disposed in substantial alignment. The first end wall (98) has a second opening (104) which is smaller than the first opening (101). The second end wall (107) has a second opening (113) disposed therein.

A second sheave assembly (160) has a first side wall (166) disposed in spaced apart relation to a second side wall (172). The second sheave assembly (160) has a first end wall (196) disposed in spaced apart relation to a second end wall (214). The first and second side walls (166, 172) have one or more first sheaves (184) and second sheaves (190) disposed thereon. The first and second end walls (196, 214) having first openings (202, 220) disposed in substantial alignment. The first end wall (196) having a second opening (208) smaller than the first opening (202).

A crosshead (120) has a central portion (133) configured to support the hook (70) therefrom. The crosshead (120) has a first stud (123) extending in a first direction and a second stud (126) extending in a second direction opposite the first direction. The first and second studs (123, 126) are sized to fit inside the aligned openings (101, 110) in the first and second end walls (98, 107) in the first sheave assembly (80) and the aligned openings (202, 220) in the first and second end walls (196, 214) of the second sheave assembly (180).

A threaded rod (170) extends through the second openings (104, 208) in the first end walls (98, 196) of the first and second sheave assemblies (80, 160).

One or more spacers (150) are configured to be mounted on one of the first and second studs (123, 126) such that the position of the first and second sheave assemblies (80, 160) on the crosshead (120) can be adjusted.

The threaded rod (170) is fixedly connected to the crosshead (120).

In another aspect of the invention, the second end wall (107) on the first sheave assembly (80) has a curved opening (113) disposed therein. The curved opening (113) extending inward from a top edge (116) of the second end wall (107).

In another aspect of the invention, the first end wall (98) of the first sheave assembly (80) has a second opening (104) disposed therein.

In yet another aspect of the invention the first end wall (196) of the second sheave assembly (160) has a second opening (208) disposed therein.

Another aspect of the invention is that a threaded rod (170) extends through the second openings (104, 208) in the first end walls (98, 196) of the first and second sheave assemblies (80, 160).

In another aspect of the invention, the threaded rod (170) is fixedly connected to the crosshead (120).

In another embodiment of the invention a wire rope hoist system is provided with a low overhead hook block assembly (10). The wire rope hoist system includes a rotating drum (50) having a spiral rope groove defined therein. A shaft is operatively associated with the rotating drum (50). A motor (60) is configured to engage with and rotate the shaft. A hoisting rope (63) is affixed to the drum (50) and is configured to wind into and unwind from the spiral rope groove. One end of the hoisting rope (63) is attached to a fixed end point (167) on a side of a hook block assembly (10) opposite from the drum (50).

A rope guide is configured to mount around the rotating drum (50). The rope guide is configured to move laterally relative to the rotating drum (50) to keep the hoisting rope (63) in the spiral rope groove when winding the hoisting rope (63) into the rope groove or unwinding it from the rope groove. The hook block assembly (10) has a first sheave assembly (80) having a first side wall (83) disposed in spaced apart relation to a second side wall (86). The first sheave assembly (80) has a first end wall (98) disposed in spaced apart relation to a second end wall (107). The first side wall (83) has a sheave (92) disposed thereon. The first and second end walls (8, 107) have first openings (101, 110) disposed in substantial alignment.

A second sheave assembly (160) has a first side wall (166) is disposed in spaced apart relation to a second side wall (172). The second sheave assembly (160) has a first end wall (196) disposed in spaced apart relation to a second end wall (214). The first side wall (166) has a sheave (184) disposed thereon. The first and second end walls (196, 214) have first openings (202, 220) disposed in substantial alignment.

A crosshead (120) has a central portion (133) configured to support a hook (70) therefrom. The crosshead (120) has a first stud (123) extending in a first direction and a second stud (126) extending in a second direction opposite the first direction. The first and second studs (123, 126) are sized to fit inside the aligned openings (101, 110) in the first and second end walls (98, 107) in the first sheave assembly (80) and the aligned openings (202, 220) in the first and second end walls 196, 214) of the second sheave assembly (160).

One or more spacers (150) are configured to be mounted on one of the first and second studs (123, 126) such that the position of the first and second sheave assemblies (80, 160) on the crosshead (120) can be adjusted.

### BRIEF DESCRIPTION OF THE DRAWINGS

FIG. 1 is a perspective view of one embodiment of a low headroom hook block of the present invention in use with a wire rope drum hoist.

FIG. 2 is a perspective view of the hook block assembly of the present invention with some of the main components shown separately to the side of the hook block assembly.

FIG. 3 is a perspective view of the hook block assembly of the present invention in a first configuration for use with a girder having a relatively narrow flange.

FIG. 4 is a side elevation view of the hook block assembly of FIG. 3.

FIG. 5 is a perspective view of the hook block assembly of the present invention in a second configuration for use with a girder having a wider flange.

FIG. 6 is a side elevation view of the hook block assembly of FIG. 5.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, debris, etc.) together with the specification, and are to be considered a portion of the entire written description of this invention. As used in the following description, the terms “horizontal”, “vertical”, “left”, “right”, “up” and “down”, as well as adjectival and adverbial derivatives thereof, (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or of rotation, as appropriate.

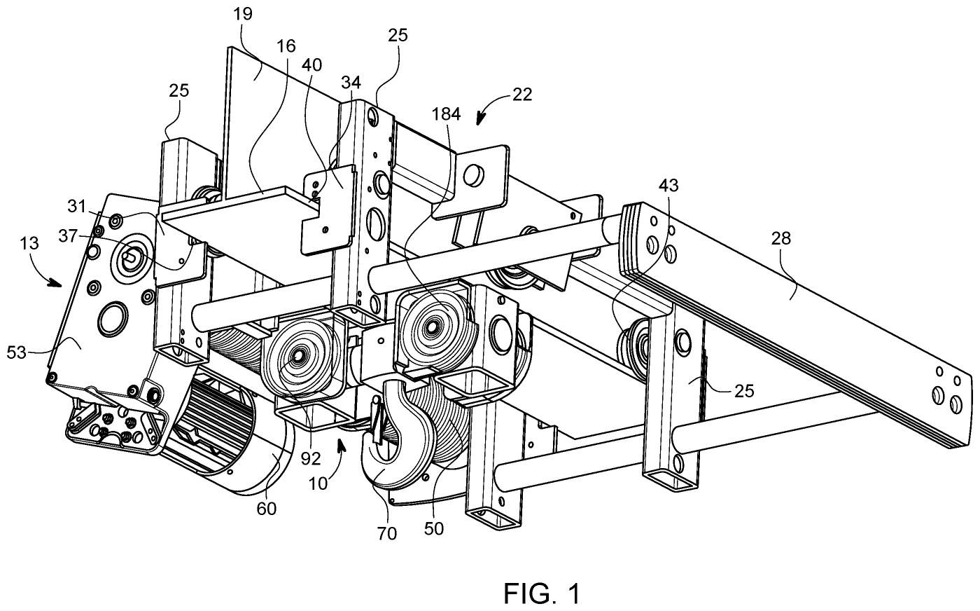

Referring now to FIGS. 1-6 generally, and initially to FIG. 1 thereof, this invention provides a hook block assembly 10 that may be used with a wire rope hoist 13. The wire rope hoist 13 may be mounted on the flange 16 of an I-beam 19. The wire rope hoist 13 may be attached to a frame 22. The frame 22 may be provided with vertical and horizontal structural members 25, 28. Opposed plates 31, 34 may be mounted on the vertical member 25. The opposed plates 31, 34 may have openings 37, 40 defined therein for receiving the ends of the flange 16. The frame 22 has wheels 43 mounted thereon that roll along the top surface of the flange 16 such that the hoist 13 can move along the I-beam 19 in the longitudinal direction relative to the I-beam 19. Accordingly, the hook block assembly 10 runs underneath the I-beam 19 along the longitudinal axis.

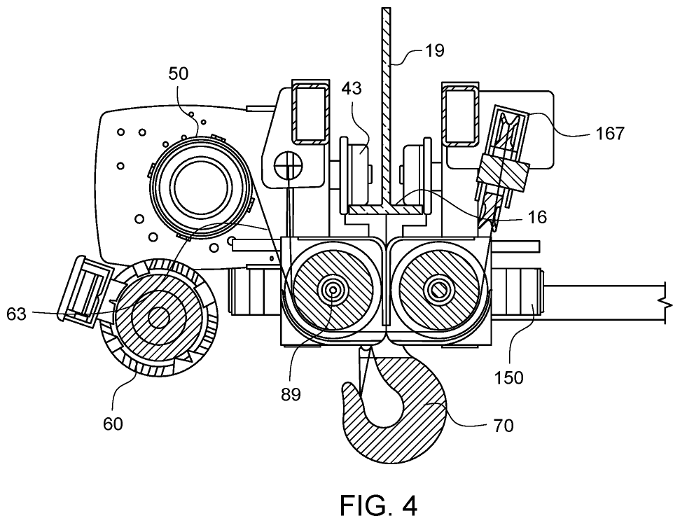

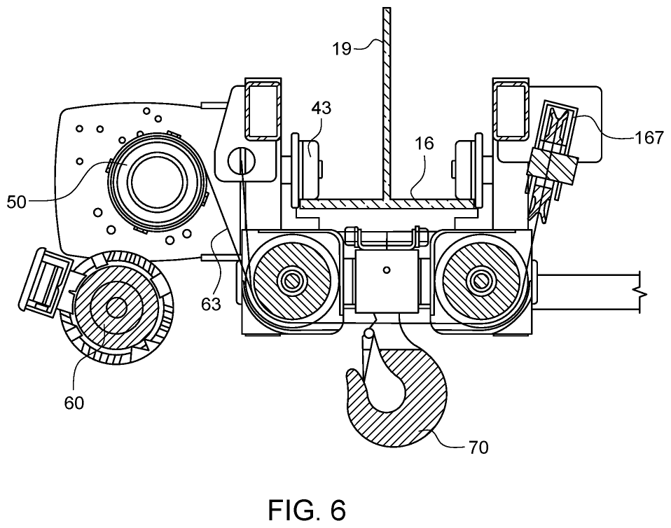

A rotating drum 50 is mounted to the side by angled support members 53, 56 and is powered by an electric motor 60. A rope 63 (FIGS. 4 and 6) extends from the rotating drum 50 downward to the hook block assembly 10 supporting a hook 70. As shown the rotating drum 50 and electric motor 60 may configured such that they are supported upward and to the left to provide headroom for the hook block assembly 10 to lift the load.

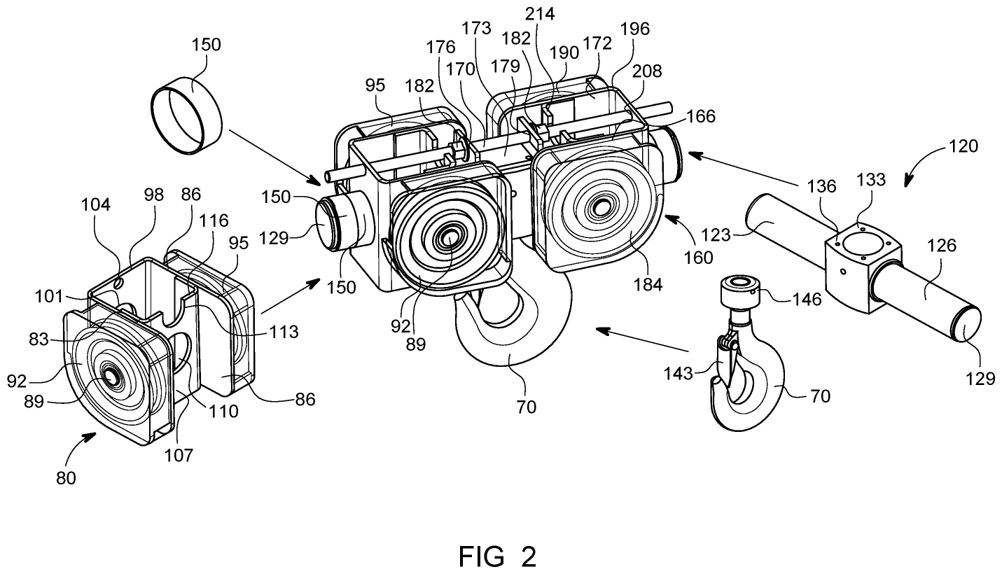

Turning to FIG. 2 and initially to the left side of the figure, a sheave assembly 80 may be provided with a pair of opposed first and second side walls 83, 86 respectively. The first and second side walls 83, 86 may be provided with pins or axles 89 that are configured to rotatably support a first sheave 92 and a second sheave 95. The first and second side walls 83, 86 may extend to and be connected to a first end wall 98. The first end wall 98 may be provided with a first central opening 101. A second opening 104 may be disposed above the central opening 101. The second opening 104 may be smaller than the central opening 104. A second end wall 107 may be disposed opposite from the first end wall 98 and may be disposed between or connected to the first and second side walls 83, 86. The second end wall 107 may be provided with a second central opening 110. A curved opening 113 may extend to the top edge 116 of the second end wall 107.

On the right side of the figure, a crosshead 120 may be provided with a first stud 123 extending in one direction and a second stud 126 extending a second direction opposite from the first direction. The first and second studs 123, 126 may be substantially cylindrical. A snap ring 129 may be provided at the end of the first and second studs 123, 126. The crosshead 120 has a central portion 133 that may be provided with a plurality of openings 136 for mounting a bracket 173 as will be described below. The central portion 133 may be configured to receive the hook 70. The hook 70 may be provided with a pivoting safety latch 143. The hook 70 may also be provided with a head 146 configured to removably attach to the crosshead 120. The hook 70 may be configured to be interchangeable for different applications, lifting requirements, and lifting configurations.

Returning to the left side of the figure, a plurality of spacers 150 may be utilized in connection with the hook block assembly 10 of the present invention as will be described in greater detail below.

In the center of FIG. 2, one embodiment of the present invention is shown. Sheave assembly 80 is mounted on the left side of the figure. On the right side of the figure, a second sheave assembly 160 is mounted on the opposite side of the crosshead 120. The second sheave assembly 160 may be a mirror image of the first sheave assembly 80. The first stud 123 extends through the first and second central openings 101 and 110 in the first and second end walls 98, 107. As shown, two spacers 150 are disposed on the first stud 123 to the left of the sheave assembly 80. The snap ring 129 at the end of the first stud 123 prevents the spacers 150 from sliding off of the end of the first stud 123.

As shown in the center of FIG. 2, an elongate member 170 may be supported at the center by a U-shaped bracket 173 that may be attached to the top of the crosshead 120. The U-shaped bracket 173 may be provided with aligned openings 176 and 179 for receiving the elongate member 170. The elongate member 170 may be provided with external threads for engaging with threads inside one or more fasteners such as nuts 182. As shown, the elongate member 170 extends through the openings 176, 179 in the U-shaped bracket 173. Toward the outside of the assembly to the left, the elongate member 170 passes through the curved opening 113 in the second end wall 107 and then through the opening 104 in the first end wall 98.

The sheave assemblies 80 and 160 are held in place on the crosshead 120 by the spacers 150. The sheave assemblies 80 and 160 are prevented from rotating relative to the cross head 120 by the position of the first and second studs 123, 126 within the central openings in the sheave assemblies 80 and 60 in combination with the position of the elongate member within the openings in the outer end walls of the sheave assemblies 80 and 160.

The crosshead 120 may be provided with a U-shaped bracket 173 at the top. The elongate member 170 is held in position relative to the crosshead 120 by engagement of threaded nuts 182 with the threads on the elongate member 170. Nuts 182 are tightened against the U-shaped bracket 173 on opposite sides to fix the threaded rod 170 relative to the crosshead 120. The combination of the fasteners 182 on the threaded rod 170 and the engagement of the first and second studs 123, 126 and spacers 150 with the first and second sheave assemblies 80, 160 hold the hook block assembly 10 together in a specific configuration.

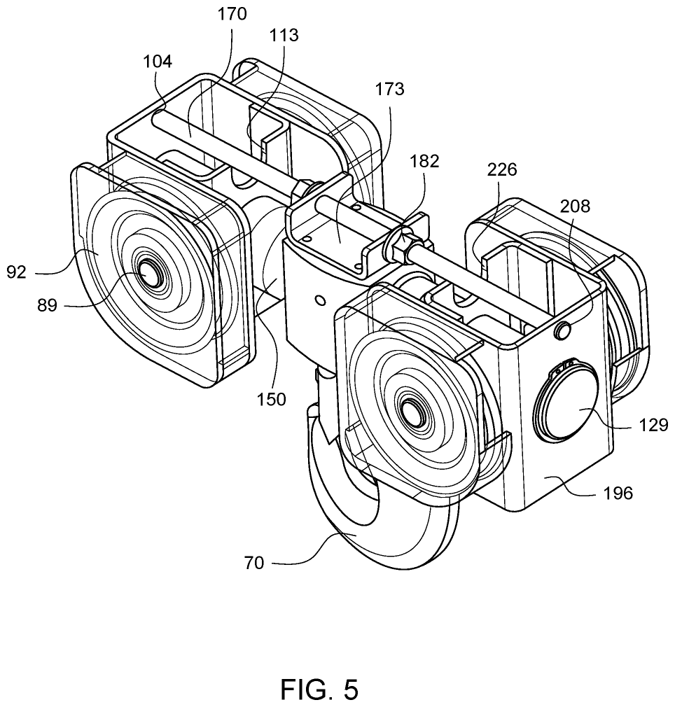

As shown in FIG. 2, one or more spacers 150 may be disposed on the first stud 123 to the left of the sheave assembly 80. In order to increase the distance between the sheave 92 on the first sheave assembly 80 and the first sheave 184 on the second sheave assembly 160, the spacers 150 may be moved to the other side of the sheave assembly as will be described in greater detail herein in connection with FIG. 5.

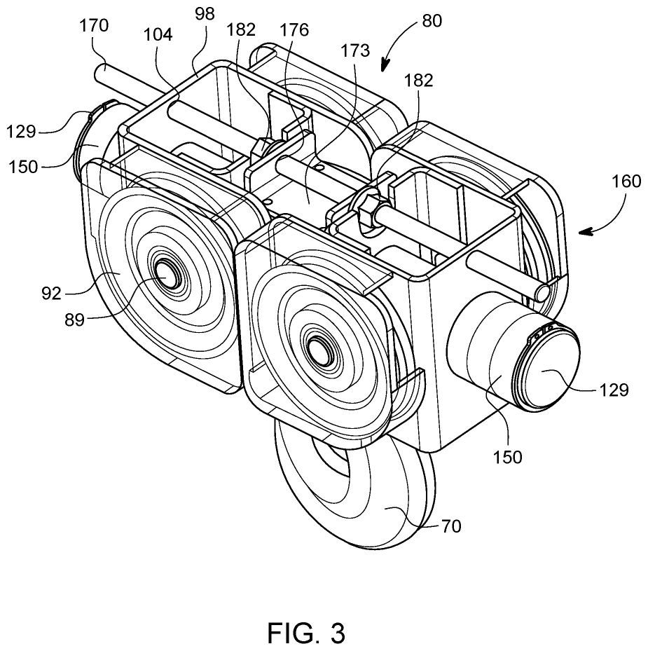

Turning to FIG. 3, a low headroom hook block assembly 10 is configured for a girder or I-beam having a narrower configuration. The sheave assemblies 80 and 160 are disposed adjacent to each other to provide the most narrow configuration possible. In order to provide this configuration, a plurality of spacers 150 are disposed on the first and second studs 123, 126 on the outsides of the sheave assemblies 80, 160. The position of the sheave assemblies along the longitudinal axis of the crosshead 120 may be adjusted by means of the spacers 150.

In FIG. 4, the wire 63 is shown extending from the rotating drum 50 at one end and extending around the sheaves 92, 184 on the hook block assembly 10 to a fixed end point 167 on the opposite side of the hook block assembly 10. When the wire 63 is paid out from the drum 50, the hook block assembly 10 is lowered which lowers the load attached to the hook 70. When the drum 50 is rotated in the opposite direction to take up the wire 63 around the drum 50, the hook 70 is lifted. FIG. 4 illustrates the highest position for the hook block assembly 10 for a relatively narrow girder flange 16. The angle of loading at the highest hook position needs to be maintained to keep the wires 63 under the permissible tension. In FIG. 4, the angle of loading is 17.56 degrees.

Turning to FIGS. 5 and 6, an alternate embodiment is shown with an I-beam 19 having a wide flange 16. The wire 63 is shown extending from the rotating drum 50 at one end and extending around the sheaves 92, 184 on the hook block assembly 10 to a fixed end point 167 on the opposite side of the hook block assembly 10. When the wire 63 is paid out from the drum 50, the hook block assembly 10 is lowered which lowers the load attached to the hook 70. When the drum 50 is rotated in the opposite direction to take up the wire 63 around the drum 50, the hook 70 is lifted. FIG. 6 illustrates the highest position for the hook block assembly 10 for a wider flange 16. The angle of loading at the highest hook position needs to be maintained to keep the wires 63 under the permissible tension. As shown the angle of loading is 21.06 degrees, and the hook block assembly 10 is shown at its highest position for the wider flange 16.

The present invention contemplates that many changes and modifications may be made. Therefore, while the presently-preferred form of the low headroom hook block for a wire hoist has been shown and described, and several modifications and alternatives discussed, persons skilled in this art will readily appreciate that various additional changes and modifications may be made without departing from the spirit of the invention, as defined and differentiated by the following claims.

1. A hook block assembly, comprising:
a first sheave assembly having a first side wall disposed in spaced apart relation to a second side wall, the first sheave assembly having a first end wall disposed in spaced apart relation to a second end wall, the first side wall having one or more first sheaves disposed thereon, the second side wall having one or more second sheaves disposed thereon, the first and second end walls having first openings disposed in substantial alignment;
a second sheave assembly having a first side wall disposed in spaced apart relation to a second side wall, the second sheave assembly having a first end wall disposed in spaced apart relation to a second end wall, the first side wall having one or more first sheaves disposed thereon, the second side wall having one or more second sheaves disposed thereon, the first and second end walls having first openings disposed in substantial alignment;
a crosshead having a central portion configured to support a hook therefrom, the crosshead having a first stud extending in a first direction and a second stud extending in a second direction opposite the first direction, the first and second studs sized to fit inside the aligned openings in the first and second end walls in the first sheave assembly and the aligned openings in the first and second end walls of the second sheave assembly;
one or more spacers configured to be mounted on one of the first and second studs such that the position of the first and second sheave assemblies on the crosshead can be adjusted

2. The hook block assembly of claim 1, wherein the second end wall on the first sheave assembly has a curved opening disposed therein, the curved opening extending inward from a top edge of the second end wall.

3. The hook block assembly of claim 1, wherein the first end wall on the first sheave assembly has a second opening disposed therein.

4. The hook block assembly of claim 3, wherein the first end wall on the second sheave assembly has a second opening disposed therein.

5. The hook block assembly of claim 4, further comprising a threaded rod extending through the second openings in the first and second end walls of the first and second sheave assemblies;

6. The hook block assembly of claim 5, wherein the threaded rod is fixedly connected to the crosshead.

7. A wire rope hoist system for raising and lowering a load, the wire rope hoist system, comprising:
a rotating drum having a spiral rope groove defined therein;
a shaft operatively associated with the rotating drum;
a motor configured to engage with and rotate the shaft;
a hoisting rope affixed to the drum and configured to wind into and unwind from the spiral rope groove, one end of the hoisting rope attached to a fixed end point on a side of a hook block assembly opposite from the drum;
a rope guide configured to mount around the rotating drum, the rope guide configured to move laterally relative to the rotating drum to keep the hoisting rope in the spiral rope groove when winding the hoisting rope into the rope groove or unwinding it from the rope groove;
the hook block assembly having a first sheave assembly having a first side wall disposed in spaced apart relation to a second side wall, the first sheave assembly having a first end wall disposed in spaced apart relation to a second end wall, the first side wall having one or more first sheaves disposed thereon, the second side wall having one or more second sheaves disposed thereon, the first and second end walls having first openings disposed in substantial alignment, the hook block assembly having a second sheave assembly having a first side wall disposed in spaced apart relation to a second side wall, the second sheave assembly having a first end wall disposed in spaced apart relation to a second end wall, the first side wall having one or more first sheaves disposed thereon, the second side wall having one or more second sheaves disposed thereon, the first and second end walls having first openings disposed in substantial alignment, the hook block assembly having a crosshead having a central portion configured to support a hook therefrom, the crosshead having a first stud extending in a first direction and a second stud extending in a second direction opposite the first direction, the first and second studs sized to fit inside the aligned openings in the first and second end walls in the first sheave assembly and the aligned openings in the first and second end walls of the second sheave assembly, the hook block assembly having one or more spacers configured to be mounted on one of the first and second studs such that the position of the first and second sheave assemblies on the crosshead can be adjusted.

8. The wire rope hoist system of claim 7, wherein the second end wall on the first sheave assembly has a curved opening disposed therein, the curved opening extending inward from a top edge of the second end wall.

9. The hook block assembly of claim 7, wherein the first end wall on the first sheave assembly has a second opening disposed therein.

10. The hook block assembly of claim 9, wherein the first end wall on the second sheave assembly has a second opening disposed therein.

11. The hook block assembly of claim 10, further comprising a threaded rod extending through the second openings in the first and second end walls of the first and second sheave assemblies.

12. The hook block assembly of claim 11, wherein the threaded rod is fixedly connected to the crosshead.

13. A wire rope hoist system with a low overhead hook block assembly, the wire rope hoist system comprising:
a rotating drum having a spiral rope groove defined therein;
a shaft operatively associated with the rotating drum;
a motor configured to engage with and rotate the shaft;
a hoisting rope affixed to the drum and configured to wind into and unwind from the spiral rope groove, one end of the hoisting rope attached to a fixed end point on a side of a hook block assembly opposite from the drum;
a rope guide configured to mount around the rotating drum, the rope guide configured to move laterally relative to the rotating drum to keep the hoisting rope in the spiral rope groove when winding the hoisting rope into the rope groove or unwinding it from the rope groove;
the hook block assembly having a first sheave assembly having a first side wall disposed in spaced apart relation to a second side wall, the first sheave assembly having a first end wall disposed in spaced apart relation to a second end wall, the first side wall having a sheave disposed thereon, the first and second end walls having first openings disposed in substantial alignment;
a second sheave assembly having a first side wall disposed in spaced apart relation to a second side wall, the second sheave assembly having a first end wall disposed in spaced apart relation to a second end wall, the first side wall having a sheave disposed thereon, the first and second end walls having first openings disposed in substantial alignment;
a crosshead having a central portion configured to support a hook therefrom, the crosshead having a first stud extending in a first direction and a second stud extending in a second direction opposite the first direction, the first and second studs sized to fit inside the aligned openings in the first and second end walls in the first sheave assembly and the aligned openings in the first and second end walls of the second sheave assembly;
one or more spacers configured to be mounted on one of the first and second studs such that the position of the first and second sheave assemblies on the crosshead can be adjusted.

14. The wire rope hoist system of claim 13, wherein the second end wall on the first sheave assembly has a curved opening disposed therein, the curved opening extending inward from a top edge of the second end wall.

15. The hook block assembly of claim 13, wherein the first end wall on the first sheave assembly has a second opening disposed therein.

16. The hook block assembly of claim 15, wherein the first end wall on the second sheave assembly has a second opening disposed therein.

17. The hook block assembly of claim 16, further comprising a threaded rod extending through the second openings in the first and second end walls of the first and second sheave assemblies.

18. The hook block assembly of claim 17, wherein the threaded rod is fixedly connected to the crosshead.
